(19) United States
(12) Patent Application Publication
(10) Pub. No.: US 2009/0144231 A1
(43) Pub. Date: Jun. 4, 2009

(54) System and Method for Adding Search Keywords to Web Content

(75) Inventors: Kazuhisa Misono, Kanagawa-ken (JP); Naoya Yamamoto, Kanagawa-ken (JP)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 12/325,593

(22) Filed: Dec. 1, 2008

(30) Foreign Application Priority Data
Dec. 4, 2007 (JP) 2007-313903

(51) Int. Cl. G06F 17/30

(52) U.S. Cl. 707/2; 707/E17.107

(57) ABSTRACT

It is an object of the present invention to improve findability (hit ratio) of a web page in a search using a search system by automatically adding useful keywords as search keys to the web page. A system includes a web content acquisition unit which acquires a web content, a keyword acquisition unit which acquires keywords arbitrarily associated with the web content from a social bookmark server, a keyword adding unit which adds the keywords acquired by the keyword acquisition unit to the web content acquired by the web content acquisition unit, and a transmitter unit which transmits the web content with the keywords added thereto upon request for acquiring the web content from a search server which provides a search service of the web content.

### FIELD OF THE INVENTION

The present invention relates to a system for adding keywords for use in searching for a web content using a search system on the Internet to the web content and a method therefor.

### BACKGROUND OF THE INVENTION

People usually use a search system (search engine) capable of searching for a web page or web content by using an arbitrary word or phrase as a search key when searching for information on the Internet. The search system uses keywords, which are recorded as meta-information on web pages automatically collected using a crawler, or words or phrases, which are included in the text of the web page. Therefore, it is effective to previously record as many keywords as possible, which are supposed to be selected by people who are going to view the web page, on the meta-information in order to have a lot of people view the web page.

In recent years, a service called “social bookmark” is provided on the Internet (for example, “The Second Times: ‘Social Bookmark’ for Sharing Browser's Favorites on the Net” by Kiyohiro Yamada, [online], ITpro, Nikkei Business Publications, Inc., Aug. 22, 2006, [searched for on Nov. 16, 2007], http://itpro.nikkeibp.co.jp/article/COLUMN/20060817/245851/; Social Bookmarking, http://en.wikipedia.org/wiki/Social_bookmarking). A web browser has a function called “bookmark” for recording a uniform resource locator (URL) of a web page to be viewed many times. The social bookmark is a service for providing a user with the “bookmark” function on a web site on the Internet to enable the user to share it with other people. The social bookmark allows a registrant to add a word or phrase for classification called “tag” to a registered web page. The user of the social bookmark is able to find web pages having the same orientation by seeing bookmarks of other people who register the same URL or seeing bookmarks of other people classified by the same tag.

### SUMMARY OF THE INVENTION

As described above, it is effective to cause the web page to be found (hit) by various search keys in searches by the search system in order to have a lot of people view the web page. There are, however, a wide variety of keywords that the visitors consider to relate to the content of the web page. Therefore, it is impossible for a creator of the web page to assume and add all of the useful keywords to the web page in advance.

Moreover, the above social bookmark allows a visitor to the web page to independently classify the web page by adding a tag to the web page so as to make good use of the classification for searches by other people. In this case, however, a search for the web page using the tag is possible only by the social bookmark with the tag added thereto. More specifically, even if a useful tag is added to a given web page in the social bookmark, it is impossible to directly search for the web page in a general search system using the word or phrase as a search key.

The present invention has been provided in view of the above problem, and it is an object of the present invention to provide a system for improving the findability (hit ratio) of a web page in searches using the search system by automatically adding useful keywords as search keys to the web page and a method therefor.

To achieve the above object, the present invention is embodied as a system described below. The system comprises: a web content acquisition unit which acquires a web content; a keyword acquisition unit which acquires keywords arbitrarily associated with the web content from a management server which manages the keywords; a keyword adding unit which adds the keywords acquired by the keyword acquisition unit to the web content acquired by the web content acquisition unit and stored in a memory; and a transmitter unit which transmits the web content with the keywords added thereto in response to a request for acquiring the web content from a search server which provides a search service of the web content.

In the above system, the web content acquisition unit, the keyword acquisition unit, the keyword adding unit, and the transmitter unit may be implemented as functions of a web server which provides the web content. Alternatively, the web content acquisition unit, the keyword acquisition unit, the keyword adding unit, and the transmitter unit may be implemented as functions of a relay server which relays a request for acquiring the web content and a response thereto exchanged between the web server which provides the web content and the search server. In the latter, the web content acquisition unit acquires the web content from the web server.

More specifically, the keyword acquisition unit acquires tags added to the web content in a social bookmark as the keywords from a social bookmark server which is the management server.

In addition, the keyword adding unit adds the keywords as meta-information described in a header of the web content.

Moreover, the present invention is embodied as a web server which provides a web content. The web server comprises: a web content providing unit which provides a web content related to a request for acquiring a web content from a search server which provides a search service of the web content upon request for the acquisition; a web content acquisition unit which acquires the web content provided by the web content providing unit; a keyword acquisition unit which acquires keywords arbitrarily associated with the web content from a management server which manages the keywords; a keyword adding unit which adds the keywords acquired by the keyword acquisition unit to the web content acquired by the web content acquisition unit; and a transmitter unit which transmits the web content with the keywords added thereto to the search server.

Furthermore, the present invention is embodied as a web content processing method. The method comprises the steps of: acquiring a web content and storing the web content in memory means; acquiring keywords arbitrarily associated with the web content from a management server which manages the keywords; adding the keywords acquired from the management server to the web content stored in the memory means as meta-information described in a header of the web content; and transmitting the web content with the keywords added thereto upon request for acquiring the web content from a search server which provides a search service of the web content.

The present invention is also embodied as a program which controls a computer to perform the above system functions or a program which causes the computer to perform processes corresponding to the steps in the above processing method. It is possible to provide the programs by distributing the programs stored in a magnetic or optical disk, a semiconductor memory, or other storage mediums or by distributing the programs via a network.

According to the present invention having the above structure, it is possible to improve the findability (hit ratio) of the web page in searches by the search system by automatically adding useful keywords as search keys to the web page.

### BRIEF DESCRIPTION OF THE DRAWINGS

FIG. 1 is a diagram schematically illustrating a processing system of a web page according to the embodiment.

FIG. 2 is a diagram illustrating a hardware configuration example of a computer implementing a processing server, a web server, a SBM server, and a search server shown in FIG. 1.

FIG. 3 is a diagram illustrating a functional configuration of the processing server of the embodiment.

FIG. 4 is a diagram illustrating a specific example of keyword information acquired from the SBM server in the embodiment.

FIG. 5 is a flowchart describing the operation of a keyword adding unit of the embodiment.

FIG. 6 is a diagram illustrating a situation where the keyword adding unit of the embodiment adds keywords to a <meta> element in a <head> element of the web content and illustrating an original <head> element.

FIG. 7 is a diagram illustrating a situation where the keyword adding unit of the embodiment adds the keywords to the <meta> element in the <head> element of the web content and illustrating a <head> element with the keywords added thereto.

FIG. 8 is a diagram illustrating a configuration example where the function of the processing server of the embodiment is implemented as a plug-in function of the web server.

FIG. 9 is a configuration example where the function of the processing server of the embodiment is implemented as a proxy server function.

### DETAILED DESCRIPTION OF THE INVENTION

Hereinafter, the present invention will be described by way of embodiments with reference to accompanying drawings.

### System Configuration

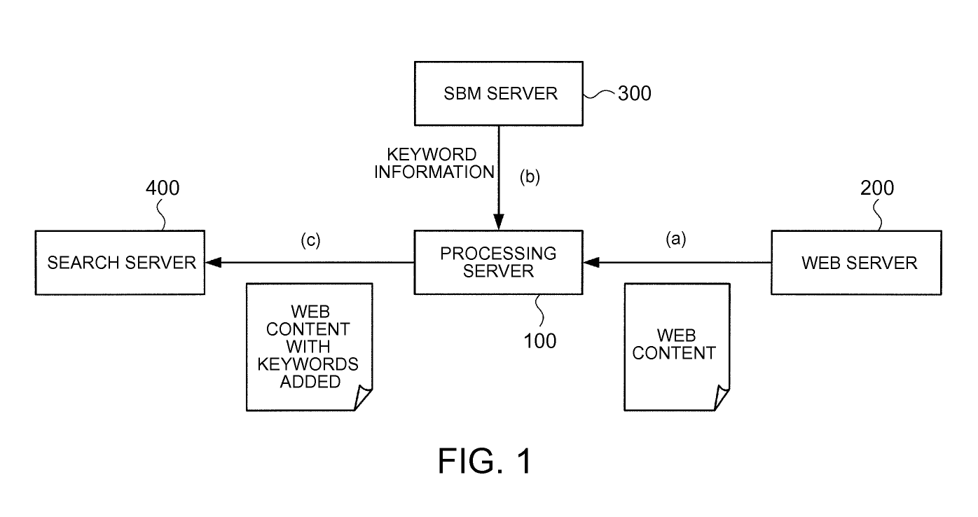

FIG. 1 shows a diagram schematically illustrating a web page processing system according to this embodiment.

In FIG. 1, a processing server 100 acquires keywords related to a given web page and automatically adds the keywords to the web page. A web server 200 provides a web content (including the web page). The web content may be stored in memory means such as a magnetic disk unit provided in the web server 200 or may be dynamically created upon receiving an access request. A social bookmark (SBM) server 300 provides a social bookmark service for sharing a bookmark on the Internet. The social bookmark service allows a registrant to associate an arbitrary word or phrase with a registered web content and add the word or phrase as a tag to the web content. The SBM server 300 manages the tag as a keyword related to the web content. A search server 400 provides a service of searching for the web content with an arbitrary word or phrase as a search key using a search engine. The search server 400 goes round sites on the Internet using a search robot such as a crawler or a web browser function so as to collect information on web contents.

The processing server 100 acquires the web content from the web server 200 (an arrow (a) in FIG. 1). Moreover, the processing server 100 acquires keyword information related to the acquired web content from the SBM server 300 (an arrow (b) in FIG. 1). The keyword information includes a tag added to the web content in the SBM server 300. The processing server 100 then adds the tag included in the acquired keyword information as a search keyword to the web content and transmits the web content with the tag to the search server 400 (an arrow (c) in FIG. 1).

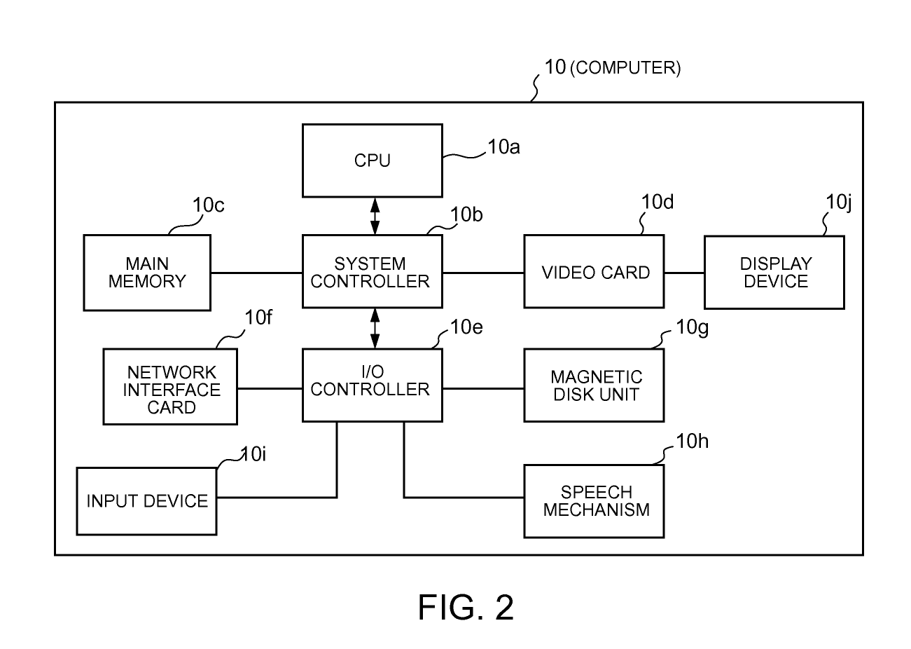

FIG. 2 shows a diagram illustrating an example of a hardware configuration of a computer implementing the processing server 100, the web server 200, the SBM server 300, and the search server 400 shown in FIG. 1.

A computer 10 shown in FIG. 2 includes a central processing unit (CPU) 10a which is computing means, a main memory 10c which is memory means, and a magnetic disk unit (hard disk drive (HDD)) 10g. Furthermore, the computer 10 includes a network interface card 10f for a connection with an external device via a network, a video card 10d and a display device 10j for performing a display output, and a speech mechanism 10h for performing a speech output. Still further, the computer 10 includes an input device 10i such as a keyboard or a mouse.

As shown in FIG. 2, the main memory 10c and the video card 10d are connected to the CPU 10a via a system controller 10b. Moreover, the network interface card 10f, the magnetic disk unit 10g, the speech mechanism 10h, and the input device 10i are connected to the system controller 10b via an I/O controller 10e. The components are connected to each other via various buses such as a system bus and an I/O bus. For example, the CPU 10a and the main memory 10c are connected to each other via a system bus or a memory bus. Furthermore, the CPU 10a, the magnetic disk unit 10g, the network interface card 10f, the video card 10d, the speech mechanism 10h, and the input device 10i are connected to each other via peripheral components interconnect (PCI), PCI express, serial AT attachment (ATA), universal serial bus (USB), accelerated graphics port (AGP) or other I/O buses.

It is needless to say that FIG. 2 merely illustrates the hardware configuration of a PC to which this embodiment is suitably applied and thus actual servers are not limited to the shown configuration. For example, it is also possible to use a configuration in which only video memory is mounted instead of the video card 10d so that the CPU 10a processes image data. Moreover, the speech mechanism 10h may be provided as a function of a chipset which constitutes the system controller 10b or the I/O controller 10e, instead of having the independent configuration. Furthermore, a drive using various optical disks or flexible disks as media may be provided as an auxiliary memory besides the magnetic disk unit 10g. Although a liquid crystal display is mainly used as the display device 10j, it is additionally possible to use an arbitrary type of display such as a CRT display or a plasma display. While the details will be described later, the processing server 100 of this embodiment may be implemented as independent hardware or can be implemented as common hardware with the web server 200.

### Functions of Processing Server

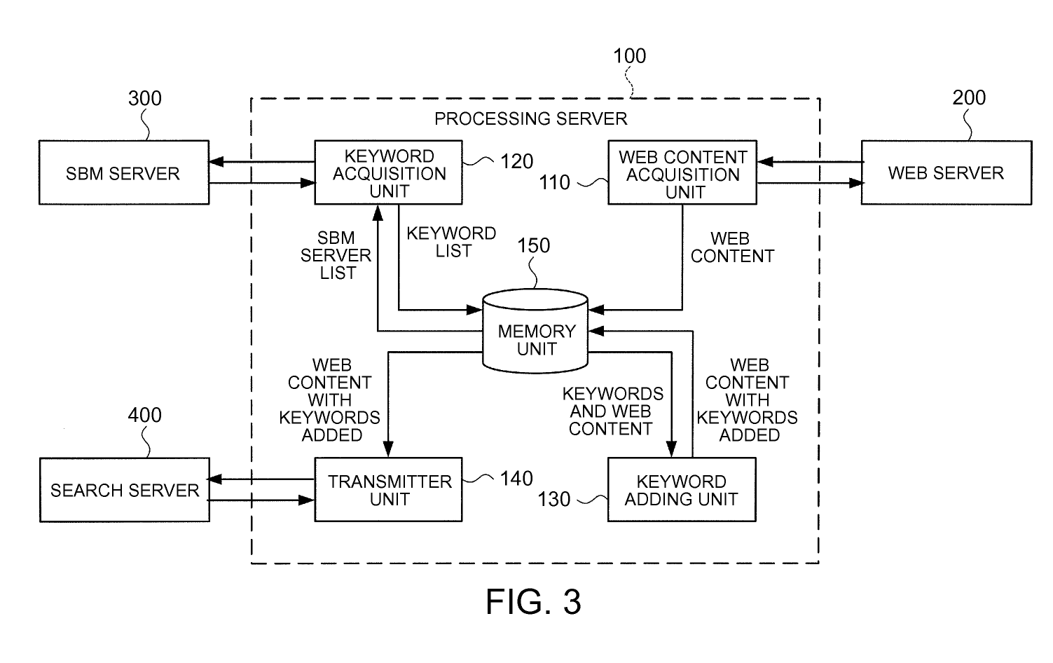

FIG. 3 is a diagram illustrating the functional configuration of the processing server 100.

As shown in FIG. 3, the processing server 100 includes a web content acquisition unit 110 which acquires a web content and a keyword acquisition unit 120 which acquires a keyword. In addition, the processing server 100 includes a keyword adding unit 130 which adds a search keyword to the web content. Furthermore, the processing server 100 includes a transmitter unit 140 which transmits the web content with keywords embedded therein to the search server 400 and a memory unit 150 which stores a social bookmark list and management information of web contents in which keywords are to be embedded. The management information of the web contents stored in the memory unit 150 includes, for example, a list of web content URLs or of web servers 200. Alternatively, it is possible to store the web contents themselves.

These functions are implemented by the program-controlled CPU 10a and the main memory 10c if the processing server 100 is formed by the computer 10 shown in FIG. 2. The program, which is stored in the magnetic disk unit 10g, is read to the main memory 10c and executed by the CPU 10a. In addition, the memory unit 150 is implemented by memory means such as, for example, the magnetic disk unit 10g.

The web content acquisition unit 110 acquires web contents from the web server 200. The web content acquisition unit 110 may acquire the web contents by regularly going round given web servers 200 or may acquire the web contents by accessing the web servers 200 using a URL specified in a request for collecting information at the timing of receiving the request from the web browser or search robot of the search server 400. Alternatively, the web content acquisition unit 110 may passively accept the web contents transmitted from the web servers 200. If the memory unit 150 stores the web contents themselves, the web content acquisition unit 110 may read and acquire desired web contents from the memory unit 150. The web server 200 previously store the web contents in the magnetic disk unit 10g or other memory means so as to read and provide the corresponding web contents from the memory means upon request from the web content acquisition unit 110. Alternatively, it is possible to dynamically create and provide web contents upon request from the web content acquisition unit 110 by using the common gateway interface (CGI), the Java servlet, or the mechanism of the web service. The web contents acquired by the web content acquisition unit 110 are stored in the memory means such as the main memory 10c and the magnetic disk unit 10g in the processing server 100.

The keyword acquisition unit 120 acquires keyword (tag) information related to a desired web content from the SBM server 300 and generates the list of keywords to be embedded in the web content (keyword list). The keyword acquisition unit 120 accesses the SBM server 300 on the basis of the list of the SBM server 300 stored in the memory unit 150 to acquire the keyword information. The keyword acquisition unit 120 may acquire the keyword information by regularly going round the SBM servers 300 registered in the list or may acquire the keyword information at the timing of receiving a request for collecting information from the web browser or search robot of the search server 400. In the case of the former, the generated keyword list is previously stored in the memory means such as the memory unit 150. In the case of the latter, the keyword acquisition unit 120 acquires the keyword information of the corresponding web content from the SBM servers 300 by using the URL specified in the request received from the search server 400. The generated keyword list is stored in the memory means such as the main memory 10c or the magnetic disk unit 10g in the processing server 100.

Usually, the SBM server 300 has a function of returning one of the following information in response to the request for acquiring the keyword information:

Users who generated bookmarks and list of tags added to the bookmarks

List of tags added to URL specified in request for acquisition and the number of times the tags have been added

The number of users is counted for each tag in the case of 1. In the case of 2, the acquired information is directly used, by which data in the format of {tags, the number of times the tags have been added} is obtained for the URL specified in the request for acquisition.

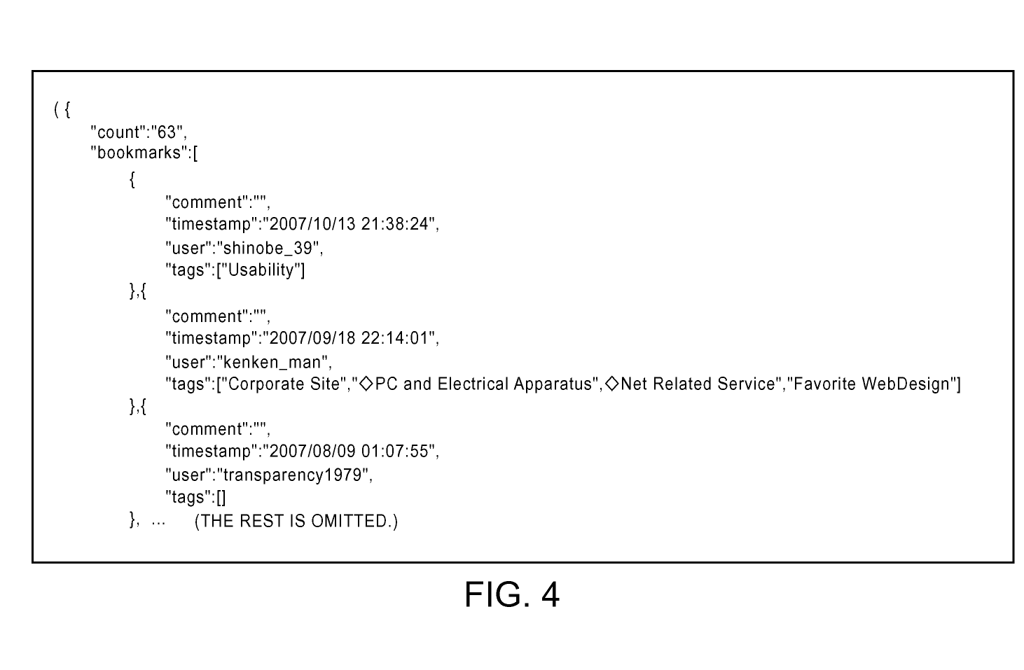

FIG. 4 is a diagram illustrating a specific example of keyword information acquired from the SBM server 300.

In the example shown in FIG. 4, the keyword information includes the number of times the tags have been added to a given web content (“count”) and a tag list (“bookmarks”). The tag list includes a comment (“comment”), a date when the tags were added (“timestamp”), a user who added the tags (“user”), and the added words or phrases of the tags (“tags”).

Moreover, the keyword acquisition unit 120 performs processing such as excluding unnecessary words or phrases from the keyword list, sequencing words or phrases within the keyword list according to which SBM server 300 the keywords were acquired from, and excluding words or phrases to which the tags were added only a few times (the number of times is less than a given number of times) from the keyword list, if necessary. This processing enables, for example, a web content creator to exclude words or phrases thought to be unfavorable for association with the web content from the keyword list though the words or phrases are added as tags in the social bookmarks.

The keyword adding unit 130 embeds keywords of the keyword list acquired and processed as necessary by the keyword acquisition unit 120 into the web content acquired by the web content acquisition unit 110. The keywords are added as meta-information described in the header of the web content. This causes the web content stored in the above memory means to be rewritten to a web content with new keywords added thereto. The web content with the keywords added is stored in the memory means such as the main memory 10c or the magnetic disk unit 10g in the processing server 100.

The search robot in the search server 400 searches the elements set between <head> and </head> in the HTML file for a <meta> element whose name attribute has the value “Keywords.” Then, the search robot interprets the value specified for the content attribute of the found <meta> element as a list of keywords delimited by a comma and uses the keyword list for the index creation with the search engine. Thus, the keyword adding unit 130 embeds the keywords into the web content as described below.

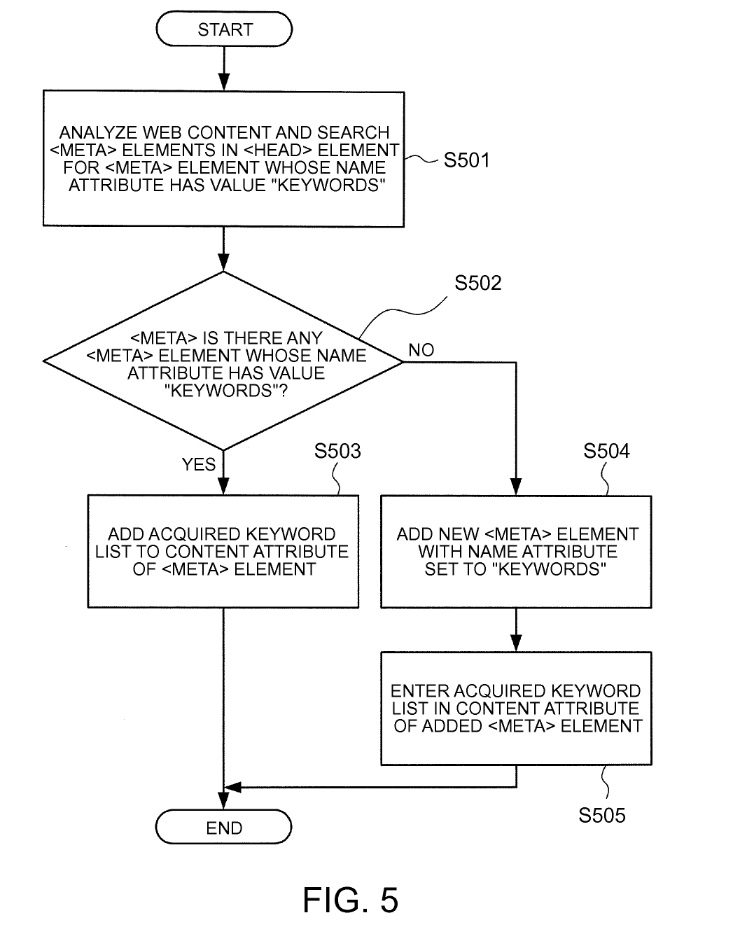

FIG. 5 shows a flowchart illustrating the operation of the keyword adding unit 130.

As shown in FIG. 5, the keyword adding unit 130 analyzes the web content (HTML document) to be processed, first, and searches <meta> elements in the <head> element for a <meta> element whose name attribute has the value “Keywords” (step 501). If there is such a <meta> element (Yes in step 502), the keyword adding unit 130 adds the keyword list, which has been acquired from the SBM server 300 and processed, to the content attribute of the <meta> element (step 503). It is arbitrary how the new keyword list is combined with the original keyword list already described in the <meta> element (addition at the beginning, addition at the end, or rearrangement in a specific method (for example, in the alphabetical order)).

On the other hand, if there is no <meta> element whose name attribute has the value “Keywords” (No in step 502), the keyword adding unit 130 adds a new <meta> element immediately after the <head> element with the name attribute set to “Keywords” (step 504). Thereafter, the keyword adding unit 130 enters the keyword list, which has been acquired from the SBM server 300 and processed, in the content attribute of the added <meta> element (step 505).

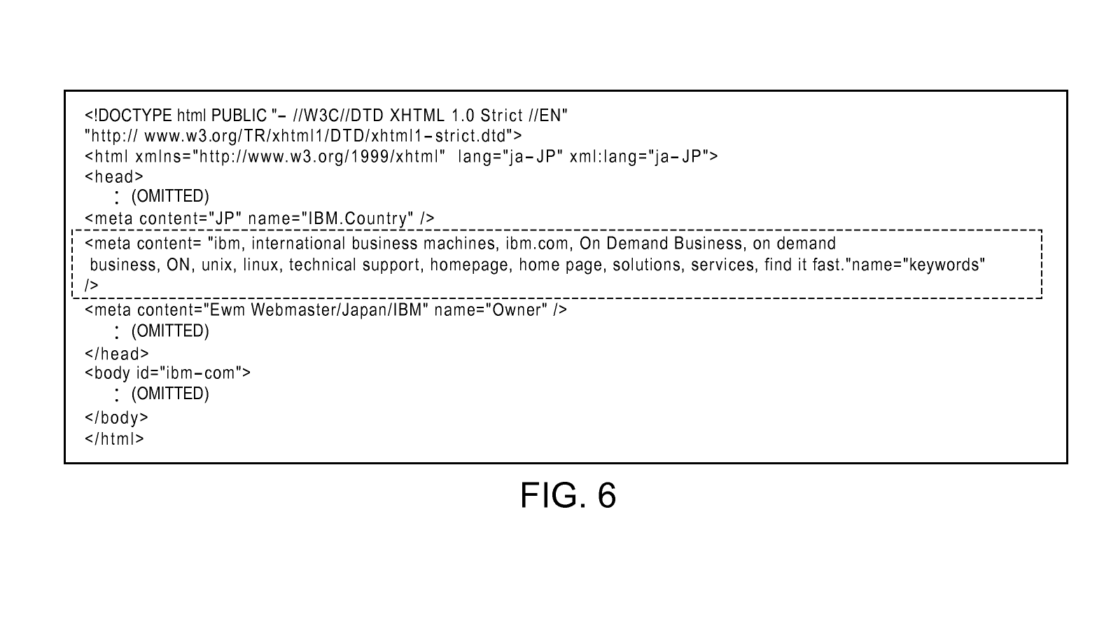

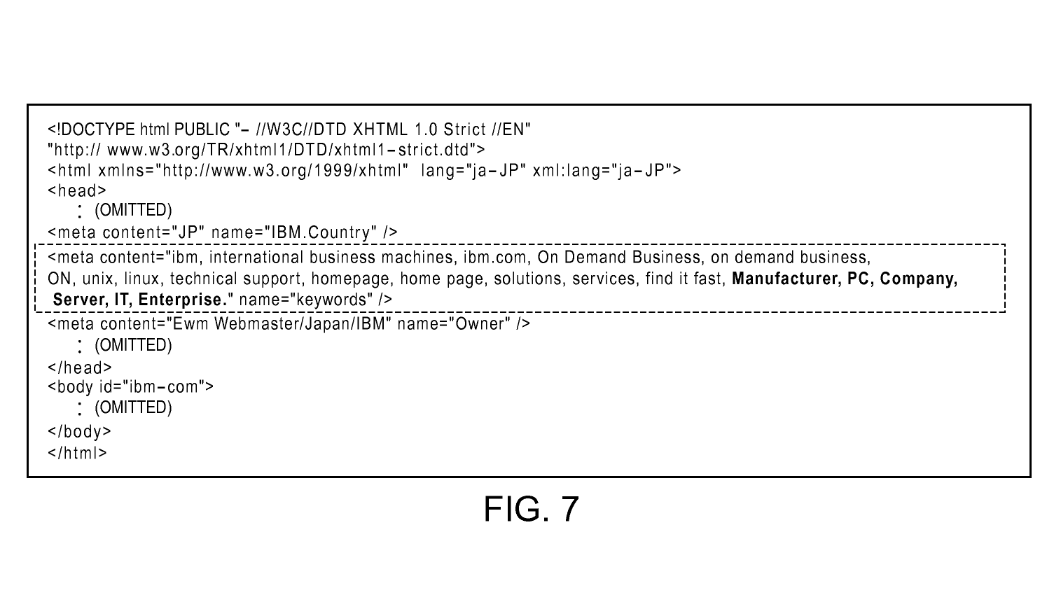

FIG. 6 and FIG. 7 illustrate the situation where the keyword adding unit 130 adds keywords to the <meta> element in the <head> element of the web content. FIG. 6 shows the original <head> element created by the web content creator. FIG. 7 shows the state after the addition of a new keyword list based on the keyword information acquired from the SBM server 300.

Referring to FIG. 6, there are a plurality of <meta> elements whose name attribute has the value “Keywords” and one (the <meta> element enclosed by a dashed line) of the <meta> elements contains “ibm, international business machines, ibm.com, On Demand Business, on demand business, ON, unix, linux, technical support, homepage, home page, solutions, services, find it fast.”

On the other hand, referring to FIG. 7, the content of the above <meta> element changes to “ibm, international business machines, ibm.com, On Demand Business, on demand business, ON, unix, linux, technical support, homepage, home page, solutions, services, find it fast, Manufacturer, PC, Company, Server, IT, Enterprise.” In other words, the bolditalic keywords “Manufacturer,” “PC,” “Company,” “Server,” “IT,” and “Enterprise” are added.

The transmitter unit 140 reads the web content with the new keywords added by the keyword adding unit 130 from the memory means upon request for acquiring the web content from the search server 400 and transmits the web content to the search server 400. In other words, the search server 400 acquires the web content processed by the processing server 100, instead of the original web content provided by the web server 200. Thereafter, this enables the web content to be found (hit) by a search with the added keywords as search keys in the search server 400.

### Embodiments

In FIG. 1, the processing server 100 is shown independently in order to clarify the roles of the individual servers. As an actual system configuration, however, it is possible to introduce the processing server 100 in various forms. There are typical examples where the processing server 100 is implemented as a plug-in function of the web server 200 and where the processing server 100 is implemented as a proxy server function for relaying the transmission and reception between the web server 200 and the search server 400.

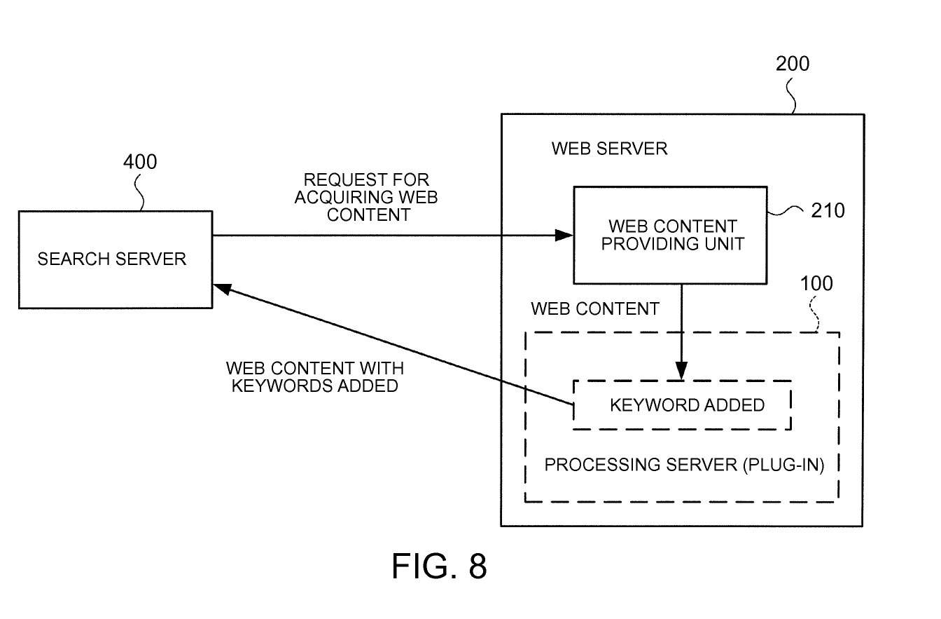

FIG. 8 shows a configuration example where the function of the processing server 100 is implemented as the plug-in function of the web server 200.

In the configuration shown in FIG. 8, the web browser or search robot of the search server 400 makes a request for a web content with a specification of a URL to the web server 200. The web server 200 has a web content providing unit 210 for providing the web content. Upon receiving the request for acquisition from the search server 400, the web content providing unit 210 then sends the URL specified in the request for acquisition and the web content of the URL to the processing server 100. The web content may be read from the storage unit or may be dynamically created upon request for acquisition from the search server 400.

The processing server 100 embeds the keywords into the received web content and returns the web content to the search server 400 that is the source of the request for acquisition. The keywords embedded in the web content may be acquired by the keyword acquisition unit 120 at the time of receiving the URL and the web content or may be previously acquired and retained by the keyword acquisition unit 120.

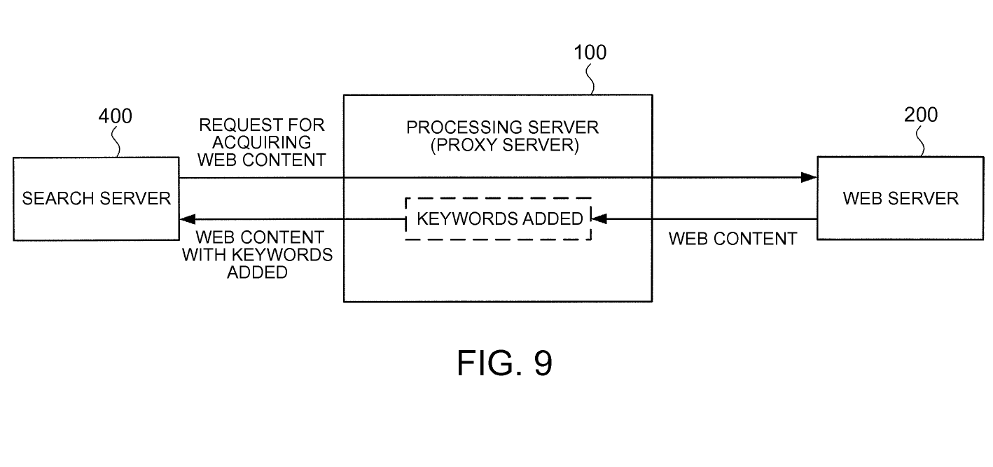

FIG. 9 shows a configuration example where the processing server 100 is implemented as a proxy server function.

In the example shown in FIG. 9, the web server 200 acquires the request for acquiring the web content transmitted from the web browser or search robot of the search server 400 via the processing server 100 which is the proxy server. Upon receiving the request for acquisition, the web server 200 returns the specified URL and the web content of the URL to the processing server 100. The web content may be read from the storage unit or be dynamically created.

The processing server 100 embeds the keywords into the web content received from the web server 200 and returns the web content to the search server 400 which is the source of the request for acquisition. The keywords embedded in the web content may be acquired by the keyword acquisition unit 120 at the time of receiving the URL and the web content or may be previously acquired and retained by the keyword acquisition unit 120.

1. A system comprising:
a web content acquisition unit for acquiring a web content and storing the web content in a memory;
a keyword acquisition unit for acquiring keywords associated with the web content from a management server which manages the keywords;
a keyword adding unit for adding the keywords acquired by the keyword acquisition unit to the web content acquired by the web content acquisition unit and storing in the memory; and
a transmitter unit for transmitting the web content with the keywords added thereto by the keyword adding unit in response to a request for acquiring the web content from a search server which provides a search service of the web content.

2. The system according to claim 1, wherein the web content acquisition unit, the keyword acquisition unit, the keyword adding unit, and the transmitter unit are implemented in a web server which provides the web content.

3. The system according to claim 1, wherein:
the web content acquisition unit, the keyword acquisition unit, the keyword adding unit, and the transmitter unit are implemented in a relay server which relays a request for acquiring the web content and a response thereto exchanged between the web server which provides the web content and the search server; and
the web content acquisition unit acquires the web content from the web server.

4. The system according to claim 1, wherein the keyword acquisition unit acquires tags added to the web content in a social bookmark as the keywords from a social bookmark server which is the management server.

5. The system according to claim 1, wherein the keyword adding unit adds the keywords as meta-information described in a header of the web content.

6. The system according to claim 1, wherein the keyword acquisition unit acquires the keywords associated with the web page specified in the request for acquiring the web content from the management server in the case of receiving the request for acquisition from the search server.

7. The system according to claim 1, wherein:
the keyword acquisition unit acquires the keywords associated with a specific web content at a given timing;
the keyword adding unit adds the keywords acquired by the keyword acquisition unit to the specific web content at a given timing and stores the web content with the keywords added thereto in memory means; and
the transmitter unit transmits the web content with the keywords added thereto stored in the memory to the search server in the case of receiving the request for acquiring the web content from the search server.

8. A web server for providing a web content, comprising:
a web content providing unit for providing a web content related to a request for acquiring a web content from a search server which provides a search service of the web content in response to a request for the acquisition;
a web content acquisition unit for acquiring the web content provided by the web content providing unit and storing the web content in memory means;
a keyword acquisition unit for acquiring keywords arbitrarily associated with the web content from a management server which manages the keywords;
a keyword adding unit for adding the keywords acquired by the keyword acquisition unit to the web content acquired by the web content acquisition unit and storing in the memory means; and
a transmitter unit for transmitting the web content with the keywords added thereto by the keyword adding unit to the search server.

9. The web server according to claim 8, wherein the keyword acquisition unit acquires tags added to the web content in a social bookmark as the keywords from a social bookmark server which is the management server.

10. The web server according to claim 8, wherein the keyword adding unit adds the keywords as meta-information described in a header of the web content.

11. A web content processing method, comprising the steps of:
acquiring a web content and storing the web content in memory means;
acquiring keywords arbitrarily associated with the web content from a management server which manages the keywords;
adding the keywords to the web content stored in the memory means as meta-information described in a header of the web content; and
transmitting the web content with the keywords added thereto in response to a request for acquiring the web content from a search server which provides a search service of the web content.

12. The method according to claim 11, wherein the step of acquiring the keywords includes acquiring tags added to the web content in a social bookmark as the keywords from a social bookmark server which is the management server.

13. A program controlling a computer to operate as:
web content acquisition means for acquiring a web content and storing the web content in a memory;
keyword acquisition means for acquiring keywords arbitrarily associated with the web content from a management server which manages the keywords;
keyword adding means for adding the keywords acquired by the keyword acquisition means to the web content acquired by the web content acquisition means and stored in the memory; and
transmitter means for transmitting the web content with the keywords added thereto by the keyword adding means upon request for acquiring the web content from a search server which provides a search service of the web content.
